(19) United States
(12) Patent Application Publication
(10) Pub. No.: US 2026/0087467 A1
(43) Pub. Date: Mar. 26, 2026

(54) EFFICIENT DATA PROCESSING USING DATA AGGREGATOR

(71) Applicant: Visa International Service Association, San Francisco, CA (US)

(72) Inventors: Koni Uttam Nayak, Dubai Marina (AE); Harsha Sathyanarayana Naga, Dubai (AE); Mikhail Aleksandrovich Podoprygalov, Moscow (RU)

(73) Assignee: Visa International Service Association, San Francisco, CA (US)

(21) Appl. No.: 19/112,560

(22) PCT Filed: Sep. 27, 2022
(86) PCT No.: PCT/RU2022/000294

§ 371 Date: Mar. 17, 2025

(51) Int. Cl. G06Q 20/08; G06Q 20/38

(52) U.S. Cl. CPC G06Q 20/085; G06Q 20/381

(57) ABSTRACT

A method is disclosed. The method includes receiving, by a processing computer, a payout validate message for a transaction from an aggregator computer, which receives a payout inquiry message from an originator computer of a plurality of originator computers. The aggregator computer is in communication with the plurality of originator computers. The payout inquiry message and the payout validate message can comprise a transaction amount for the transaction. The processing computer validates the payout validate message, and then transmits a payout validate response message to the aggregator computer. The payout validate response message comprises data regarding validation of the payout validate message. After transmitting the payout validate response message to the aggregator computer, the method includes receiving, by the processing computer, from the aggregator computer, a payout message. The method also includes transmitting, by the processing computer, a payout response message to the aggregator computer.

### CROSS-REFERENCES TO RELATED APPLICATIONS

None.

### BACKGROUND

Transaction systems such as cross-border payment systems have many challenges. A current cross-border payment system has each sender's bank (e.g., originator bank) connected to a domestic correspondent bank. The domestic correspondent bank is then connected to a payment processing network to perform cross-border remittance of the money to the recipient's bank. This process is often inefficient, fragmented, and is not transparent as there are many domestic correspondent banks connected to the payment processing network. Each domestic bank needs to individually address issues such as technical validation, delivery estimation, and foreign exchange rate conversions. Such processes can lead to slow transaction speeds and sometimes data loss.

Embodiments of the disclosure address this problem and other problems individually and collectively.

### SUMMARY

One embodiment includes a method comprising: receiving, by a processing computer, a payout validate message for a transaction from an aggregator computer, which receives a payout inquiry message from an originator computer of a plurality of originator computers, the aggregator computer in communication with the plurality of originator computers, the payout inquiry message and the payout validate message comprising a transaction amount for the transaction; validating, by the processing computer, the payout validate message; responsive to validating the payout validate message, transmitting, by the processing computer, a payout validate response message to the aggregator computer, the payout validate response message comprising data regarding validation of the payout validate message; after transmitting the payout validate response message to the aggregator computer, receiving, by the processing computer, from the aggregator computer, a payout message; and transmitting, by the processing computer, a payout response message to the aggregator computer.

Another embodiment includes a method comprising: receiving, by an aggregator computer, a payout inquiry message from an originator computer of a plurality of originator computers; transmitting, by the aggregator computer to a processing computer, a payout validate message for a transaction, which validates the payout validate message; receiving, by the aggregator computer from the processing computer, a payout validate response message comprising data regarding validation of the payout validate message; transmitting, by the aggregator computer, a payout message to the processing computer; and receiving, by the aggregator computer, a payout response message from the processing computer.

A better understanding of the nature and advantages of embodiments of the invention may be gained with reference to the following detailed description and accompanying drawings.

### BRIEF DESCRIPTION OF THE DRAWINGS

FIG. 1 shows a swim-lane diagram of the cross-border remittance message sequence.

FIG. 2 shows a swim-lane diagram of the cross-border remittance message sequence for a cancelled transaction.

FIG. 3 shows a swim-lane diagram of the cross-border remittance message sequence for a returned transaction.

FIG. 4-6 show screenshots of a user experience when conducting a cross-border remittance according to embodiments.

FIG. 7 shows a block diagram of a processing computer according to embodiments.

FIG. 8 shows a block diagram of an aggregator computer according to embodiments.

### DETAILED DESCRIPTION

Before discussing specific embodiments in detail, some terms may be described in detail.

A “user” may include an individual or a computational device. In some embodiments, a user may be associated with one or more personal accounts and/or mobile devices. In some embodiments, the user can be a sender of funds or a recipient of funds.

A “user device” may be any suitable device that can interact with a user device (e.g., a payment card or mobile phone). User devices may be in any suitable form. Some examples of user devices include cellular phones, PDAs, personal computers (PCs), tablet computers, and the like. In some embodiments, where a user device is a mobile device, the mobile device may include a display, a memory, a processor, a computer-readable medium, and any other suitable component. A user that is a sender can have a user device, which can be a sender device. A user that is a recipient can have a recipient device, which can be a recipient device.

A “processor” may include any suitable data computation device or devices. A processor may comprise one or more microprocessors working together to accomplish a desired function. The processor may include CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A sender associated with an originator (e.g., sender bank) operating an originator computer can perform a transaction involving cross-border remittance to transfer value (e.g., money) to a recipient associated with a recipient entity (e.g., recipient's bank) operating a recipient entity computer. To perform the transaction, the original entity sends the transfer value to a domestic correspondent entity (e.g., domestic correspondent bank). The domestic correspondent entity can then send the transfer value to a foreign correspondent entity via a processing network. The foreign correspondent bank can then send the transfer value to the recipient entity, completing the transaction.

There are problems with such method of performing the transaction involving cross-border remittance to transfer value. One problem is that such method lacks visibility. There can be hundreds of originators and recipient entities, and multiple domestic correspondent entities and foreign correspondent entities. For example, if there are 100 originators and 50 domestic correspondent entities, then there are 5000 possible combinations just on one side of a cross-border remittance system. Because there can be so many combinations of entities that can be involved for the transaction, predicting the cost and time associated with all the remittances can be difficult as each entity can charge different fees and can take different times to process transactions. It also can lead to payment data loss as there can be some inconsistencies in processing between entities with so many different combinations of transaction routes. Another problem is that current cross-border remittance transactions are slow as each domestic entity needs to individually address issues such as technical validation, delivery estimation, and foreign exchange rate conversions for each transaction. It typically takes around three to five business days to complete the transaction.

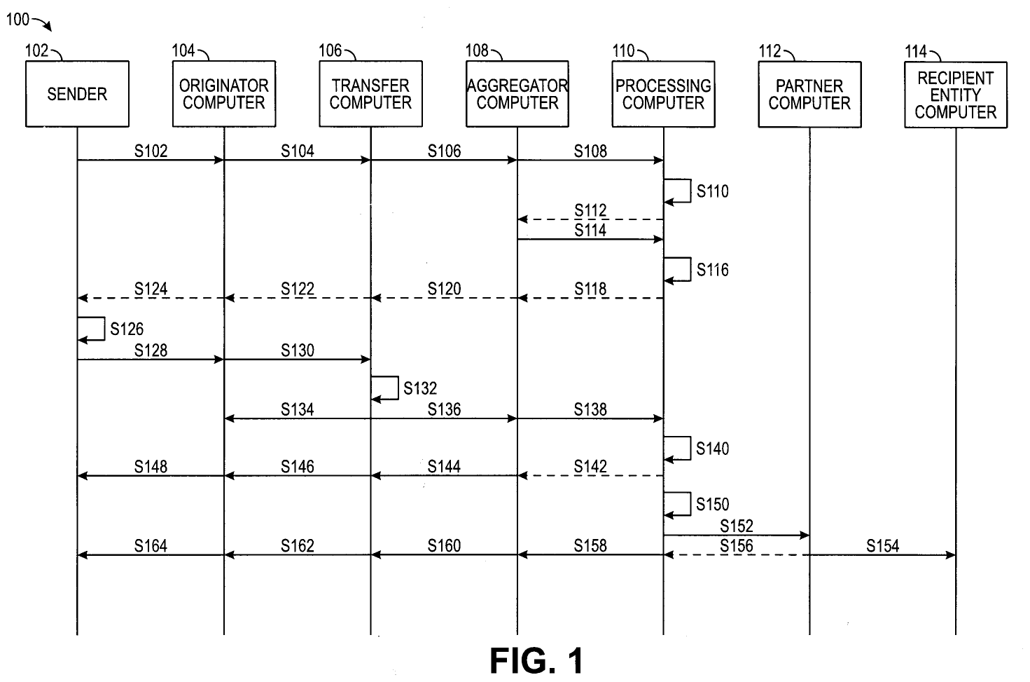

FIG. 1 shows a system diagram and a flow diagram of a method according to embodiments. In the method, a real-time payment is sent from a sender 102 to a recipient (not shown) associated with the recipient entity computer 114, which may be operated by a recipient entity such as a financial institution (e.g., a bank) that holds an account of the recipient.

The system includes an originator computer 104, a transfer computer 106, an aggregator computer 108, a processing computer 110, and a partner computer 112 in addition to the recipient entity computer 114. These computers may be in operative communication with each other.

The originator computer 104 can be operated by an originator, which may be a financial institution (e.g., a bank) that holds an account of the sender 102.

The transfer computer 106 can perform real-time transfers of funds between the originator computer 104 and the aggregator computer 108. An example of a transfer computer may be a computer that is operated by FPS or faster payment service.

The processing computer 110 can be in operative communication with the aggregator computer 108 and the partner computer 112 to facilitate a cross-border remittance. A recipient entity can be associated with the recipient entity computer 114. The recipient can be associated with the recipient entity computer 114 by having an account in the recipient entity. The partner computer 112 can transfer the payment to the recipient entity computer 114, and the recipient entity computer 114 can credit the recipient's account in the recipient entity of the payment.

The transfer computer 106 can be a computer capable of performing real-time payment transactions (e.g., faster payment service (FPS)). The aggregator computer 108 can be operated by an aggregation entity and can be in communication with a plurality of originator computers. In some embodiments, the aggregator computer 108 may maintain a matching account (e.g., pool account) for each originator computer in the plurality of originator computer. The aggregator computer 108 can act as a gateway to the processing computer 110 for the plurality of originator computers.

The processing computer 110 may include a server computer that is used process data. In some embodiments, a processing computer can be for processing transactions from a network. In some embodiments, the processing computer may be coupled to a database and may include any hardware, software, other logic, or combination of the preceding for servicing the requests from one or more client computers or user devices. The processing computer may comprise one or more computational apparatuses and may use any of a variety of computing structures, arrangements, and compilations for servicing the requests from one or more client computers or user devices. In some embodiments, the processing computer may operate multiple server computers. In such embodiments, each server computer may be configured to process a transaction for a given region or manages transactions of a specific type based on transaction data.

The processing computer 110 may include data processing subsystems, networks, and operations used to support and deliver authorization services, exception file services, and clearing and settlement services. An exemplary processing computer may include VisaNet™. Networks that include VisaNet™ can process credit card transactions, debit card transactions, and other types of commercial transactions. VisaNet™ includes an integrated payments system (Integrated Payments system) which processes authorization requests and a Base II system, which performs clearing and settlement services. The processing computer may use any suitable wired or wireless network including the Internet.

The processing computer 110 may process transaction-related messages (e.g., authorization request messages and authorization response messages) and determine the appropriate destination computer (e.g., issuer computer/authorizing entity computer) for the transaction-related messages. In some embodiments, the processing computer may authorize transactions on behalf of an issuer. The processing computer may also handle and/or facilitate the clearing and settlement of financial transactions.

The partner computer 112 can be operated by a network partner entity such as a financial institution. The financial institution can be a hub or gateway to a plurality of recipient entity computers operated by recipient entities such as recipient financial institutions (e.g., recipient banks) that hold accounts of recipients. In some embodiments, partner computer 112 can maintain a matching account (e.g., pool account) for each recipient entity computer in the plurality of recipient entity computers.

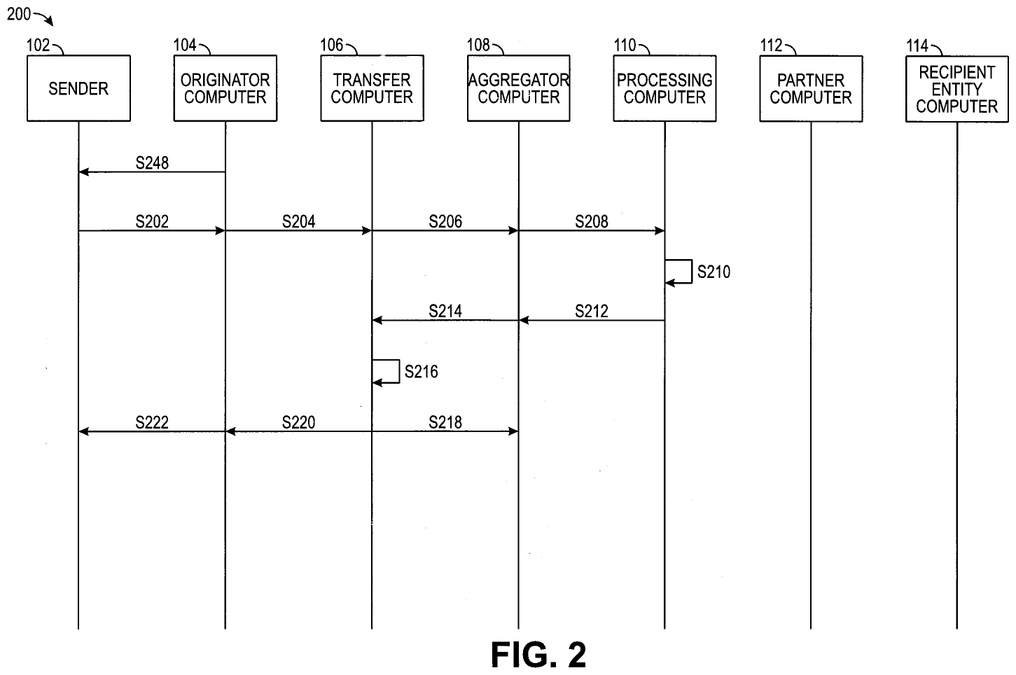

Each of the entities in FIG. 1 (as well as FIGS. 2-4) may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

In some embodiments, the sender 102, the originator computer 104, the transfer computer 106, and the aggregator computer 108 may be one country (e.g., the United States), while the partner computer 112, the recipient entity computer 114, and the recipient that has an account maintained by the recipient entity computer 114 may be in another country (e.g., France). The overall system can efficiently and securely allow for the cross-border transfer of funds from the sender 102 to the recipient.

One embodiment of the invention includes a method comprising receiving, by a processing computer, a payout validate message for a transaction from an aggregator computer, which receives a payout inquiry message from an originator computer of a plurality of originator computers. The aggregator computer is in communication with the plurality of originator computers. The payout inquiry message and the payout validate message can comprise a transaction amount for the transaction. The processing computer validates the payout validate message, and then transmits a payout validate response message to the aggregator computer. The payout validate response message comprises data regarding validation of the payout validate message. After transmitting the payout validate response message to the aggregator computer, the method includes receiving, by the processing computer, from the aggregator computer, a payout message. The method also includes transmitting, by the processing computer, a payout response message to the aggregator computer.

In step S102, the sender 102 can use a user device such as a sender device to communicate with the originator computer 104 (e.g., via an application or browser on the user device) to enter data to perform a transfer of funds from an account of the sender 102 to an account of a recipient (not shown in FIG. 1). In some embodiments, the sender 102 and the recipient may reside in different countries. The data that is entered may include transaction detail including at least a transaction amount, a currency of the country in which the user wants to remit money to, and a statement narrative, and recipient detail including at least a first name of the recipient, a last name of the recipient, and a recipient account number.

In step S104, after receiving the data to perform the transfer of funds from the account of the sender 102 to the account of the recipient, the originator computer 104 can generate a payout inquiry message. The payout inquiry message can include a payment instruction, originator data, transaction data, recipient data, and sender data. The originator data can include an originator ID, an originator name, and an originator address. The payout inquiry message may also have a transaction identifier that can identify the transaction. The transaction identifier can be present in some or all the subsequent messages in FIG. 1 to tie the messages to the same transaction. The payout inquiry message can be used by the originating entity operating the originator computer 104 to inquire as to whether the funds transfer requested by the sender 102 is feasible, the time that it will take to conduct the funds transfer, and any other information (e.g., the currency exchange rate used for the transfer) used by the originator computer 204 or the sender 202 to authorize the funds transfer.

The transaction data can include details of the transaction. The transaction data can include at least a transaction amount, a currency of the country in which the user wants to remit money to, and a statement narrative.

The recipient data can include at least a first name of the recipient, a last name of the recipient, and a recipient account number (e.g., an IBAN number) of the recipient's financial institution.

The sender data can include at least a first name of the sender, a last name of the sender, a sender's address, a sender reference number, and a source of funds (e.g., a masked account number of the sender's account).

After generating the payout inquiry message, in step S104, the originator computer 204 can send the payout inquiry message to the transfer computer 106.

In step S106, after receiving the payout inquiry message, the transfer computer 106 can send the payout inquiry message to the aggregator computer 108.

In step S108, the aggregator computer 108 can send a payout validate message to the processing computer 110 via a first API (application programming interface) such as a payout validate API, or any other suitable means. The payout validate message can contain at least the same information as in the payout inquiry message, and can also include information regarding the aggregator computer 108 (e.g., an ID or address).

In step S110, after receiving the payout validation message, the processing computer 110 validate the payout validate message. The processing computer 110 can perform a technical validation process, and can estimate a delivery time for the funds transfer. The technical validation can comprise checking whether the payout validate message has all the implementation details necessary to successfully conduct the transaction. For example, a country such as United Kingdom might have different implementation details for a cross-border transaction than France. For instance, the United Kingdom may have more implementation details for incoming cross-border funds transfers than France. The processing computer 110 can check the data in the payout validation message to determine if it complies with the implementation details for the country in which the recipient resides. In this regard, the processing computer 110 can have a table which lists various countries with the required implementation details to perform cross-border transactions and possible expected funds transfer times for each of the countries.

In step S112, after performing the validation process on the payout validate message, the processing computer 110 can send a payout validate response message to the aggregator computer 108. The payout validate response message can indicate that the technical validation was successful (or not successful), and can further provide an estimated time to conduct the funds transfer.

In step S114, after the aggregator computer 108 receives the payout validate response message, the aggregator computer 108 can send a rate inquiry request message to the processing computer 110. The rate inquiry request message can be an API call by the processing computer 110 via a third API such as an exchange rate inquiry API to determine a conversion rate and/or processing fee for the requested funds transfer.

In step S116, the processing computer 110 can determine the conversion rate and processing fees for the funds transfer. In some embodiments, the conversion rate can be determined using the address or location of the sender 102 and/or the originator (e.g., the sender's bank), and the currency described in the transaction detail in the payout inquiry and the payout validate messages described above.

In step S118, after determining the currency conversion rate for the requested funds transfer, the processing computer 110 can transmit a rate inquiry response message comprising the conversion rate and/or any processing fee to the aggregator computer 108.

Note that in some embodiments, the rate inquiry steps S114, S116, and S118 can be omitted if the transfer is not a cross-border transfer, or they can be combined with the payout validate messages in steps S108, S110, and S112.

After step S118, the aggregator computer can store the data in the payment inquiry message, the payout validate response, and the rate inquiry response in a database along with the above described transaction identifier. This data may be saved so that it can be used to build or generate a payout message as in step S138 below.

In step S120, after receiving the rate inquiry response message, the aggregator computer 108 can generate a payout inquiry response message and send it to the transfer computer 106. The payout inquiry response message can comprise some or all the information in the payout validate response message in step S112 and the rate inquiry response message in step S118.

In step S122, after receiving the payout inquiry response message, the transfer computer 106 can transmit the payout inquiry response message to the originator computer 104.

In step S124, the originator computer 104 can present (e.g., via an application or browser) some or all the data in the payout inquiry response message to the sender 102 via the sender's user device. Such data may include an estimated delivery time for the funds transfer (e.g., 1 day), a conversion rate (e.g., 1.1 francs per dollar), a processing fee, an amount to be debited from the account of the sender 102, the amount to be credited to the recipient.

In step S126, after receiving the data regarding the funds transfer, the sender 102 can analyze the data regarding the funds transfer and can review any terms and conditions of the funds transfer. The sender 102 can then indicate on the user device of the sender 102 that the sender 102 agrees to the funds transfer.

In step S128, the sender's agreement can then be provided to the originator computer 104.

In step S130, after the originator computer 104 receives the agreement from the sender 102, the originator computer 104 can build a real time funds transfer message to transfer funds for at least the amount of the current funds transfer from the originator computer 104 to the aggregator computer 108 via the transfer computer 106.

In step S132, after receiving the real time funds transfer message, the transfer computer 106 can perform a real time funds transfer process from the originator computer 104 to the aggregator computer 108 for at least transaction amount. The aggregator computer 108 can maintain a single account where the real time transfer of funds is received from the originator of the originator computer 104 and other originators operating other originator computers. Examples of real time funds transfer systems include FPS (Faster Payment Service), FedNow service, etc. The transfer of money between the originator computer 104 and the aggregator computer 108 may be a domestic transfer in some embodiments.

In step S134, the transfer computer 106 can send a confirmation of the successful real-time funds transfer to the originator computer 104. The confirmation can indicate that the transaction amount has been debited to the sender's account.

In step S136, the transfer computer 106 can send a confirmation regarding real-time funds transfer to the aggregator computer 108. The confirmation can indicate that the transaction amount has been credited to an account associated with aggregator operating the aggregator computer 108.

At this point in the process, the aggregator computer 108 has the funds needed to perform the funds transfer from the sender 102 to the recipient.

In step S138, after receiving the funds from the originator computer 104, the aggregator computer 108 can transmit (e.g., via a second API such as a payout API) the payout message to the processing computer 110. The payout message can have the necessary data needed to facilitate the payment from the sender to the recipient. The aggregator computer 108 can retrieve the data regarding the funds transfer stored after step S118.

In step S140, the processing computer 110 after receiving the payout message from the aggregator computer 108, the processing computer 110 can validate the payout message. The processing computer 110 can validate the payout message in any suitable manner including validating the originator data, the transaction data, the recipient data, and the sender data. Validation can include checking to see that such data is authentic and/or is not on a negative list, and that the data has properly formatted for processing. Once validated, the processing computer 110 can queue the payout message for screening.

In step S142, while the payout message is waiting in the queue for screening, a payout response message can be sent from the processing computer 110 to the aggregator computer 108. The payout response message can be a notification indicating the payout has been received by the aggregator computer 108.

In steps S144, S146, and S148, a status notification regarding the funds transfer can be sent from the aggregator computer 108 to the transfer computer 106, from the transfer computer 106 to the originator computer 104, and from the originator computer 104 to the sender 102 (via the sender's user device).

In step S150, the processing computer 110 can perform a screening process for the transaction after validating the payout message. An example of performing a screening process can be detecting any suspicious activity such as securities fraud according to anti-money laundering (AML) rules.

In step S152, upon the successful payout screening, the processing computer 110 can send the payout message to the partner computer 112. The partner computer 112 can be operated by a financial institution that operates in the country of the recipient. The payout message can transfer funds from the aggregator computer 108 to the partner computer 112 via the processing computer 110. In some cases, the transfer can occur in real time.

In step S154, after the partner computer 112 receives the payout message, the partner computer 112 can send the payout message to the recipient entity computer 114. The recipient entity (e.g., a financial institution or bank that holds an account of the recipient) can then inform the recipient that the funds associated with the funds transfer have been received. In some embodiments, the partner computer 112 can then transfer the funds to the recipient entity computer 114 via an automated, rapid paymerit process such as clearing house (ACH) process or a real time payment (RTP). J process. The recipient entity computer 114 can then credit the recipient account for the transfer amount.

In step S156, the partner computer 112 can send a payout response message indicating a successful transfer of funds to the recipient to the processing computer 110.

In steps S158, S160, S162, and S164 a final status notification of the transfer of value can be transmitted from the processing computer 110 to the sender 102 via the aggregator computer 108, the transfer computer 106, and the originator computer 104.

In some embodiments, after step S140 in FIG. 1, processing computer 110 can request additional information to successfully complete the payout screening. The processing computer 110 can perform a screening process for the transaction after validating the payout message. An example of performing a screening process can be detecting any suspicious activity such as securities fraud according to anti-money laundering (AML) rules. The processing computer 110, during screening, may require additional information from the originator computer 104 to process the transaction. The additional information may include credential information, the purpose of funds transfer, etc. The processing computer 110 can obtain the additional information and can complete the screening process for the funds transfer.

FIG. 2 diagram illustrates a system and a flow diagram showing a remittance cancellation process initiated by the sender 102. A funds transfer transaction can be cancelled by the sender 102 before the transfer of funds occurs between the aggregator computer 108 and the partner computer 112.

In step S248, a status notification of the processing computer receiving the payout response message can be sent from the originator computer 204 to the sender 202. This is similar to step S148 in FIG. 1.

In step S202, the sender 202 can send a payout cancel request message to the originator computer 104.

In steps S204, S206, and S208, the payout cancel request message can be transmitted from the originator computer 204 to the processing computer 210 via the transfer computer 206 and the aggregator computer 208.

In step S210, upon receiving the payout cancel request message, the processing computer 210 can check that the transfer of funds between the aggregator computer 108 and the partner computer 112 via the processing computer 110 has not occurred.

In step S212, after verifying that the transfer of funds has not yet occurred, the processing computer 110 can cancel the transaction and send a payout cancel response message to the aggregator computer 108. The payout cancel response message can comprise the amount that was supposed to be transferred to the recipient.

In step S214, the payout cancel response message can be sent from the aggregator computer 108 to the transfer computer 106.

In step S216, the transfer computer can initiate a real time value transfer from the aggregator computer 108 to the originator computer 104. In some embodiments, during the real time value transfer, the transfer computer 106 can send instructions to a central bank of the sender's country, and perform a settlement between the originator and the aggregator. The transfer of value (e.g., money) between the originator computer 104 and the aggregator computer 108 may be a domestic transfer.

In step S218, the transfer computer 106 can send a confirmation of the successful real-time value transfer to the aggregator computer 108. The confirmation can indicate that the value has been debited to a matching account of the originator in the aggregator computer 108.

In step S220, the transfer computer 106 can send a confirmation for the successful real-time value transfer to the aggregator computer 108. The confirmation can indicate that the transaction amount has been credited to the sender's account in the originator computer 104.

In step S222, once the sender's account is credited, the originator computer 104 can send a notification to the sender 102 of the successful cancellation of the remittance.

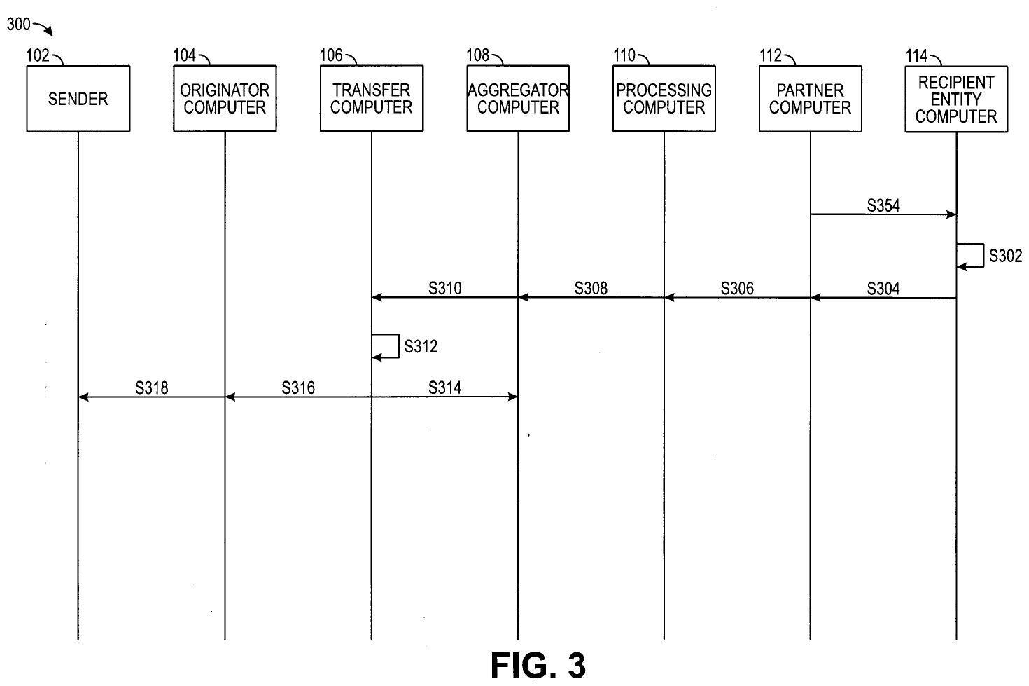

FIG. 3 shows a system and a flow diagram of a remittance message sequence for a returned transaction by a recipient entity computer 114.

In step S354, the partner computer 112 can send the payout message to the recipient entity computer 114. This is similar to step S154 in FIG. 1. The network partner entity associated with the partner computer 112 can then transfer the value of the transfer amount to the recipient entity operating the recipient entity computer 114 via automated clearing house (ACH) or real time payment (RTP). The recipient entity computer 114 can then credit the recipient's account for the transfer amount.

In step S302, the recipient entity computer 114 can review the payout message. Upon reviewing the payout message, the recipient entity computer 114 can reject the transaction and fail to credit the recipient account for the transaction amount. The recipient entity computer 114 may reject the transaction due to a poor credit standing, recipient account being blocked, failed screening, etc.

In step S304, a payout return message can be built by the recipient entity computer 114 comprising a notification of the transaction rejection. In some embodiments, the payout return message can comprise the reasons for rejection. The payout return message can then be sent from the recipient entity computer 114 to the partner computer 112.

In steps S306, S308, and S310, the payout return message can be sent from the partner computer 112 to the transfer computer 106 visa the processing computer 110 and the aggregator computer 108.

In step S312, the transfer computer can initiate a real time value transfer from the aggregator computer 108 to the originator computer 104.

In step S314, the transfer computer 106 can send a confirmation of the successful real-time value transfer to the aggregator computer 108. The confirmation can indicate that the value has been debited to a matching account of the originator in the aggregator computer 108.

In step S316, the transfer computer 106 can send a confirmation for the successful real-time value transfer to the aggregator computer 108. The confirmation can indicate that the transaction amount has been credited to the sender's account in the originator computer 104.

In step S318, once the sender's account of the originator computer 104 is credited, the originator computer 104 can send a notification to the sender 102 of the successful cancellation of the remittance.

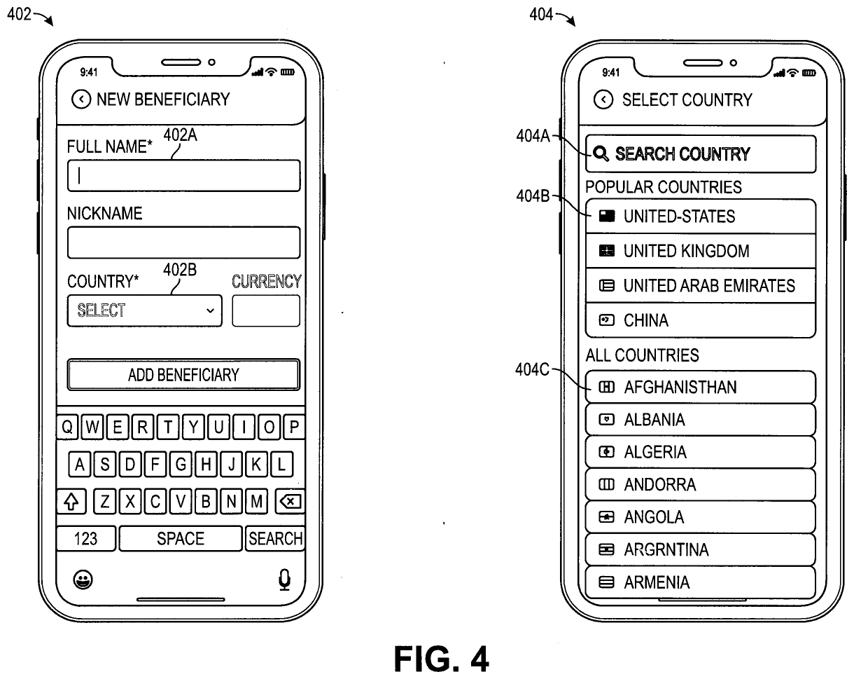

FIGS. 4-6 show screenshots that a user may see when conducting interactions according to embodiments. It can illustrate an example flow diagram of the actual interaction the sender 102 has with a user device for remittance. The user device can have a program or application in its user device that the user can interact to perform a transaction (e.g., a transfer transaction such as a cross-border remittance). The program or the application can be associated with an originator (e.g., sender's bank) operating an originator computer.

The user may have selected an option prior to screen 402 of performing a cross-border remittance. Screen 402 can be the first screen that may be displayed to the user upon selecting the option to perform the cross-border remittance.

In screen 402, the user can be prompted to fill in recipient's information in the application. Since the user's information including originator detail and sender detail are stored by in the originator, the application may ask the sender to provide recipient's information for the cross-border remittance. The application can prompt the user with an input field 402A to fill full name of the recipient and an input field 402B to fill the country of the recipient. Screen 402 can additionally provide an input field for the sender to write a nickname of the recipient. The user can click the input field 402B to select the country.

In screen 404, the user can be presented with a list of countries from which the user can select. The user can search the recipient's country by using a search field 404A. The screen can also display a list 404B showing popular countries and a list 404C showing all countries the user can select. The user can choose the country the recipient belongs to. Upon clicking the country, in this example United Kingdom, a new screen is presented in 502.

In screen 502, the user can be presented with a similar screen as screen 402 of FIG. 4, but with the input fields populated. In this specific example, the user filled in an input field 502A with the name “Brian Miller” and selected an input field 502B with the country “United Kingdom” along with an input field 502C with “British pound sterling (GBP)”. The input field 502C to select the currency is given as the country may have multi-currency system. For example, in this figure, the user might select Euros instead of GBP. Once the name, country, and the currency are selected, the user can then select a button 502D of “Add beneficiary”to continue with the transaction.

In screen 504, the user is presented with an input field 504A for the transaction amount in sender's currency and an input field 504B for the transaction amount in recipient's currency. The currency of the sender is displayed in an input field 504C and the currency of the recipient is displayed in an input field 504D. Further details of the recipient can be filled in a box 504E in the screen 504 that displays the transaction detail and recipient information.

In screen 506, the user is presented with the screen to enter notes for a transaction 506A, a name of the bank 506B, a IBAN number 506C, and a swift code 506D of the recipient. These information may be required for the sender to successfully perform the transaction to the correct recipient. Upon filling in the information, the sender can choose a button 506E to “add card”.

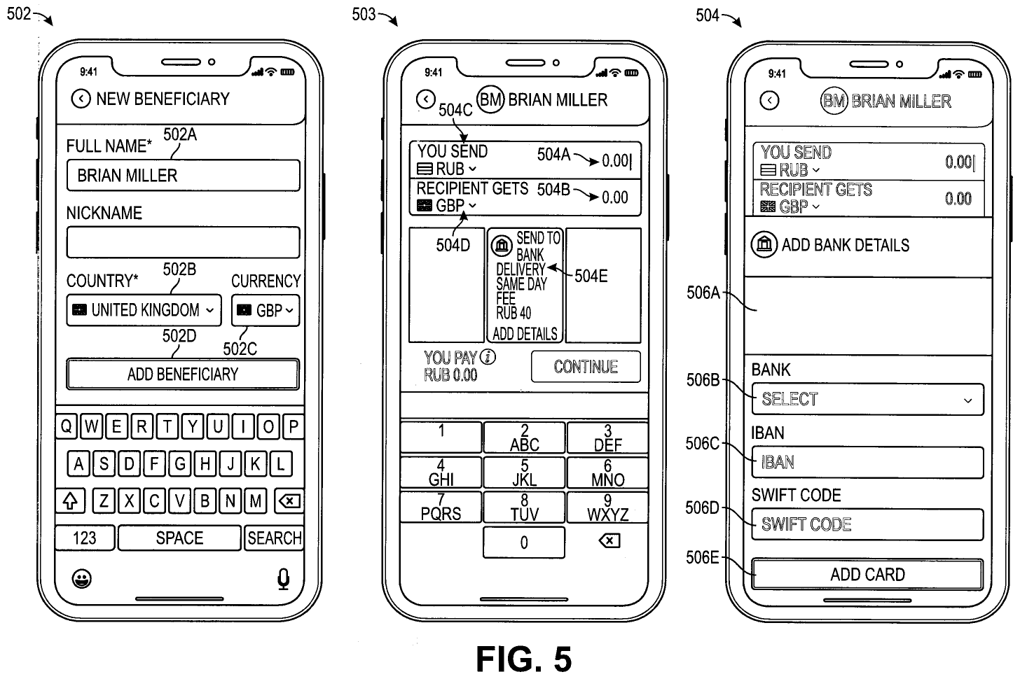

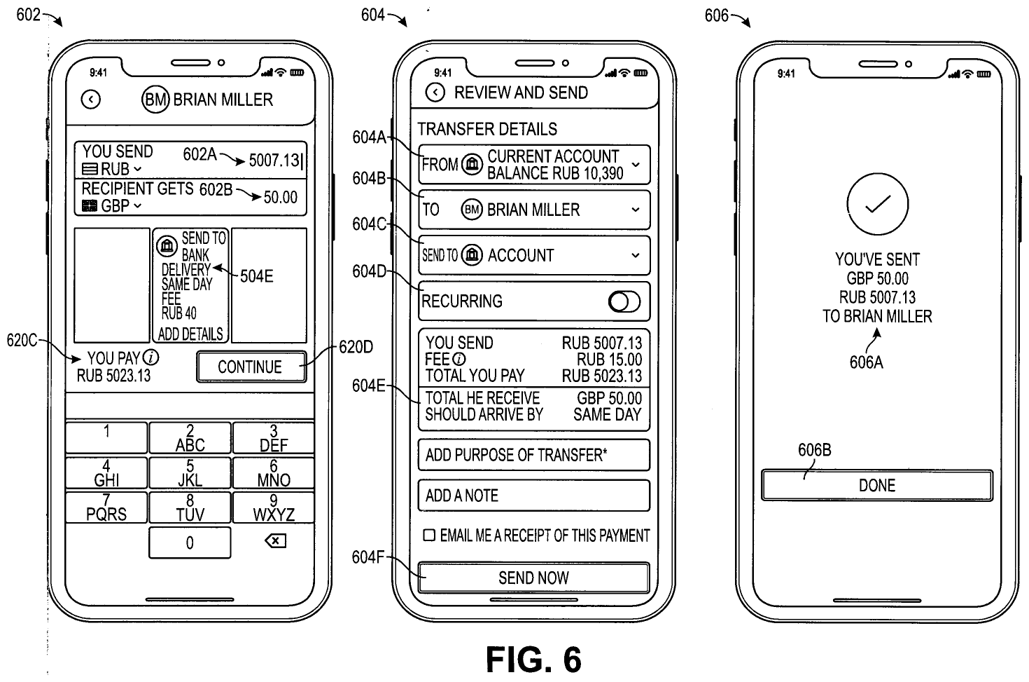

Referring to FIG. 6, in screen 602, the user can be presented with a similar screen as screen 504 of FIG. 5, but with the input fields populated. The user enters the amount that it wants to send to, and this value is computed along with the sum of the fee for the transaction. In this example, it is shown that the user in Russia enters in an input field 50 GBP to a person in Great Britain. This 50 GBP is converted to 5007.13 Rubles (RUB), and is displayed in an input field 602A. Along with the conversion, it calculates a total amount including a fee the sender needs to pay for the transfer. The conversion can go other way, where the sender can enter the amount in Rubles that it wants to send to the recipient in the input field 602A, and the application calculates the amount in the input field 602B in GBP. The total amount is displayed in a small box 602C, where the sender needs to pay the total amount of 5023.13 RUB to transfer 50 GBP to the recipient. Once the user is notified with this information, the user can click a button 602D to continue.

In screen 604, the summary/review page can be displayed. The summary page can comprise sender's account 604A, a recipient information 604B, a recipient's account information 604C, an option 604D of selecting whether it is a recurring payment, a summary of transaction 604E comprising the breakdown of the payment. The user can review the transaction details one last time before sending the amount to the recipient. Once the user checks the transaction details, the user can confirm the transaction by clicking a button 604F.

In screen 606, a confirmation page can be displayed. Details of the transaction can be shown in 606A. To exit the confirmation page, the user can select a “Done” button 606B.

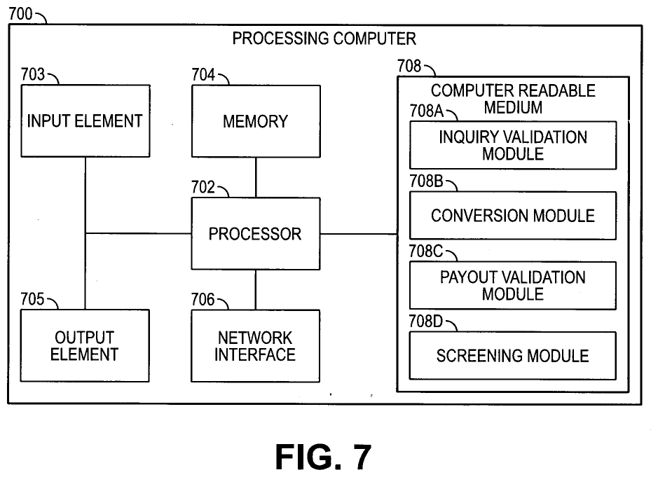

FIG. 7 shows a block diagram of a processing computer 700 according to embodiments. The processing computer 700 may comprise a processor 702. The processor 702 may be coupled to an input element 703, an output element 705, a memory 704, a network interface 709, and a computer readable medium 708. The computer readable medium 708 may comprise any suitable number and types of software modules.

Examples of input elements may include microphones, keypads, touchscreens, sensors, etc. Examples of output elements may include speakers, display screens, and tactile devices.

The memory 704 may be used to store data and code. The memory 704 may be coupled to the processor 702 internally or externally (e.g., via cloud-based data storage), and may comprise any combination of volatile and/or non-volatile memory such as RAM, DRAM, ROM, flash, or any other suitable memory device. In some embodiments, the memory 704 may store the data items of a payload.

The network interface 706 may include an interface that can allow the processing computer 700 to communicate with external computers. The network interface 706 may enable the processing computer 700 to communicate data to and from another device such as an aggregation computer, a partner computer, etc. Some examples of the network interface 706 may include a modem, a physical network interface (such as an Ethernet card or other Network Interface Card (NIC)), a virtual network interface, a communications port, a Personal Computer Memory Card International Association (PCMCIA) slot and card, or the like. Data transferred via the network interface 706 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 706 and other devices via a communications path or channel. As noted above, any suitable communication path or channel may be used including but not limited to a wire or cable, fiber optics, a telephone line, a cellular link, a radio frequency (RF) link, a WAN or LAN network, the Internet, etc.

The computer readable medium 708 may comprise code, executable by the processor 702, for performing operations comprising: receiving a payout validate message for a transaction from an aggregator computer, which receives a payout inquiry message from an originator computer of a plurality of originator computers, the aggregator computer in communication with the plurality of originator computers, the payout inquiry message and the payout validate message comprising a transaction amount for the transaction; validating the payout validate message; responsive to validating the payout validate message, transmitting a payout validate response message to the aggregator computer, the payout validate response message comprising data regarding validation of the payout validate message; after transmitting the payout validate response message to the aggregator computer, receiving from the aggregator computer, a payout message; and transmitting a payout response message to the aggregator computer.

The computer readable medium 708 may comprise several software modules including, but not limited to, an inquiry validation module 708A, a conversion module 708B, a payout validation module 708C, and a screening module 708D.

The inquiry validation module 708A can perform a technical validation on a payout validate message received from an aggregator computer. The technical validation can comprise checking whether the payout validate message has all the implementation details necessary to successfully conduct the transaction. For example, United Kingdom might require different implementation details than Russia for cross-border remittance. The technical validation makes sure that the payout validation message has all the implementation details specific to recipient's country. The inquiry validation module 708A can additionally estimate a delivery time for a value transfer.

The conversion module 708B can check the currency conversion rate of a transaction amount in a rate inquiry request message. The conversion module 708B can additionally compute a processing fee to perform the transaction (e.g., value transfer transaction such as cross-border remittance).

The payout validation module 708C can comprise validating a payout message. The payout validation module 708C can validate originator detail, transaction detail, recipient detail, and sender detail of the payout message. The screening module 708D can screen the payout message after validating the payout message. An example of performing a screening process can be detecting any suspicious activity such as securities fraud according to anti-money laundering (AML) rules.

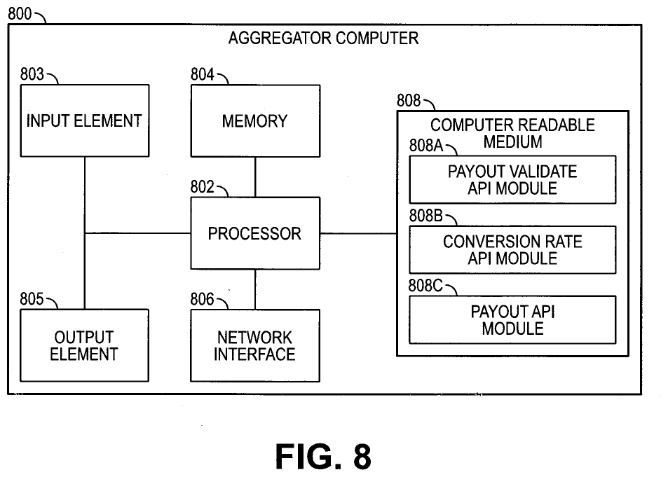

FIG. 8 shows a block diagram of an aggregator computer 800 according to embodiments. The aggregator computer 800 may comprise a processor 802. The processor 802 may be coupled to an input element 803, an output element 805, a memory 804, a network interface 806, and a computer readable medium 808. The computer readable medium 808 may comprise any suitable number and types of software modules.

Examples of input elements may include microphones, keypads, touchscreens, sensors, etc. Examples of output elements may include speakers, display screens, and tactile devices.

The memory 804 may be used to store data and code. The memory 804 may be coupled to the processor 802 internally or externally (e.g., via cloud-based data storage), and may comprise any combination of volatile and/or non-volatile memory such as RAM, DRAM, ROM, flash, or any other suitable memory device. In some embodiments, the memory 804 may store the data items of a payload.

The network interface 806 may include the same or different features as the network interface 706 in FIG. 7, so the description thereof is incorporated herein.

The computer readable medium 808 may comprise code, executable by the processor 802, for a method comprising: receiving a payout inquiry message from an originator computer of a plurality of originator computers; transmitting, to a processing computer, a payout validate message for a transaction, which validates the payout validate message; receiving, from the processing computer, a payout validate response message comprising data regarding validation of the payout validate message; transmitting a payout message to the processing computer; and receiving a payout response message from the processing computer.

The computer readable medium 808 may comprise several software modules including, but not limited to, a payout validate API module 808A, a conversion rate API module 808B, a payout API module 808C, and a notification module 808D.

The payout validate API module 808A can send a payout validate message to a processing computer 700. The payout validate message can be an API call of the payout inquiry message received from a transfer computer for technical validation and delivery estimation. The conversion rate API module 808B can send a rate inquiry request message to the processing computer 700. The rate inquiry request message can be an API call of the payout inquiry message received from the transfer computer for a currency conversion rate and calculating a currency conversion rate.

The payout API module 808C can send a payout message received from the aggregator computer as an API call to the processing computer. By sending the payout message as an API call, the processing computer 700 can validate the payout message and screen the payout message.

Embodiments of the invention have several technical advantages. One advantage of the invention is the transaction is more transparent. Embodiments can use a single aggregator computer. The aggregator computer can address issues such as technical validation, delivery estimation, and foreign exchange rate conversions for many originators. Because there is a single aggregator computer (and optionally a single partner computer) facilitating the transaction (e.g., a cross-border funds transfer) over a processing network, the combination of entities that can be involved for the transaction is limited to the number of originator entities and recipient entities. For example, as noted in the example above, if there are 100 originators and 50 correspondent entities as in a conventional system, there can be 5000 possible combinations. However, in embodiments, there can be one aggregator for the 100 originators, so there are only 100 possible combinations. Further, embodiments can use APIs to standardize the formatting and the transmission of data between an aggregator computer and a processing computer. The combination of these features can result in more accurate, more predictable, and faster transactions as compared to conventional systems. Yet another advantage of embodiments is that the use of the transfer computer. The transfer computer can enable a real-time funds transfer between any originators and their corresponding aggregator, thereby ensuring that the time from when a sender requests a funds transfer and when a recipient actually receives the funds is minimized.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processing computer, a payout validate message for a transaction from an aggregator computer, which receives a payout inquiry message from an originator computer of a plurality of originator computers, the aggregator computer in communication with the plurality of originator computers, the payout inquiry message and the payout validate message comprising a transaction amount for the transaction;
validating, by the processing computer, the payout validate message;
responsive to validating the payout validate message, transmitting, by the processing computer, a payout validate response message to the aggregator computer, the payout validate response message comprising data regarding validation of the payout validate message;
after transmitting the payout validate response message to the aggregator computer, receiving, by the processing computer, from the aggregator computer, a payout message; and
transmitting, by the processing computer, a payout response message to the aggregator computer.

2. The method of claim 1, wherein the transaction is a cross-border funds transfer for a sender in one country and a recipient in another country.

3. The method of claim 1, wherein validating the payout validate message comprises:
determining, by the processing computer, that the payout validate message has implementation details needed to successfully conduct the transaction.

4. The method of claim 1, further comprising:
receiving, by the processing computer, a rate inquiry request message from the aggregator computer;
determining a conversion rate for the transaction; and
responsive to determining the conversion rate for the transaction, transmitting, by the processing computer, a rate inquiry response message comprising the conversion rate to the aggregator computer.

5. The method of claim 1, wherein the transaction is a value transfer transaction to transfer value from a sender associated with an originator operating the originator computer to a recipient, wherein the recipient is associated with a receiving entity operating a recipient entity computer, the recipient entity computer being in communication with the processing computer.

6. The method of claim 1, wherein the aggregator computer is a gateway to the processing computer for the plurality of originator computers.

7. The method of claim 1, wherein the payout validate message is provided from the aggregator computer to the processing computer via a first API and the payout validate response message is provided from the processing computer to the aggregator computer via the first API.

8. The method of claim 7, wherein the payout message is provided by the aggregator computer to the processing computer via a second API, and the payout response message is provided by the processing computer to the aggregator computer via the second API.

9. The method of claim 1, further comprising:
validating, by the processing computer, the payout message;
performing, by the processing computer, a screening process for the transaction after validating the payout message.

10. The method of claim 9, further comprising:
transmitting, by the processing computer, a screening information request to provide additional information for the screening process; and
receiving, by the processing computer, a screening information response message with the additional information.

11. The method of claim 9, further comprising, after performing the screening process:
transmitting, by the processing computer, the payout message to a partner computer, which transfers the transaction amount to a recipient entity computer, which credits a recipient account for the transaction amount.

12. The method of claim 1, wherein the aggregator computer stores data in the payout inquiry message in a database, and uses the data to generate the payout message.

13. The method of claim 12, wherein the payout validate message, the payout validate response message, the payout message, and the payout response message each contain a same transaction identifier.

14. The method of claim 1, further comprising:
transmitting, by the processing computer, a status notification for the transaction to the aggregator computer, which transmits the status notification to the originator computer.

15. The method of claim 1, wherein the aggregator computer transmits the payout response message to the originator computer via a transfer computer, and wherein after the payout response message is received by the originator computer, the originator computer 104 builds a real time funds transfer message to transfer at least the transaction amount from the originator computer to the aggregator computer via the transfer computer.

16. A system comprising:
a processing computer, the processing computer comprising a processor and a computer readable medium, the computer readable medium comprising code executable by the processor for performing operations including:
receiving a payout validate message for a transaction from an aggregator computer, which receives a payout inquiry message from an originator computer of a plurality of originator computers, the aggregator computer in communication with the plurality of originator computers, the payout inquiry message and the payout validate message comprising a transaction amount for the transaction;
validating the payout validate message;
responsive to validating the payout validate message, transmitting a payout validate response message to the aggregator computer, the payout validate response message comprising data regarding validation of the payout validate message;
after transmitting the payout validate response message to the aggregator computer, receiving from the aggregator computer, a payout message; and
responsive to validating the payout message, transmitting a payout response message to the aggregator computer.

17. The system of claim 16, further comprising the aggregator computer.

18. A method comprising:
receiving, by an aggregator computer, a payout inquiry message from an originator computer of a plurality of originator computers;
transmitting, by the aggregator computer to a processing computer, a payout validate message for a transaction, which validates the payout validate message;
receiving, by the aggregator computer from the processing computer, a payout validate response inessage comprising data regarding validation of the payout validate message;
transmitting, by the aggregator computer, a payout message to the processing computer; and
receiving, by the aggregator computer, a payout response message from the processing computer.

19. The method of claim 18, wherein the payout inquiry message and the payout validate message comprise a transaction amount for the transaction.

20. The method of claim 18, wherein in the method, the aggregator computer and the processing computer communicate via APIs.
